(19) United States
(12) Patent Application Publication
(10) Pub. No.: US 2024/0262704 A1
(43) Pub. Date: Aug. 8, 2024

(54) MINERALIZATION METHOD OF CALCIUM CHLORIDE-TYPE FROM LITHIUM-CONTAINING SALT LAKE BRINE BY EVAPORATION AND BRINE MIXING

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Xueming LAI, Foshan (CN); Shengkang LI, Foshan (CN); Rui DONG, Foshan (CN); Wenjian XIAO, Foshan (CN); Honghui TANG, Foshan (CN); Changdong LI, Foshan (CN)

(73) Assignees: GUANGDONG BRUNP RECYCLING TECHNOLOGY CO., LTD., Foshan, GD (CN); HUNAN BRUNP RECYCLING TECHNOLOGY CO., LTD., Changsha, HN (CN); HUNAN BRUNP EV RECYCLING CO., LTD., Changsha, HN (CN)

(21) Appl. No.: 18/260,031

(22) PCT Filed: Aug. 26, 2022
(86) PCT No.: PCT/CN2022/115292

§ 371 Date: Jun. 29, 2023

(30) Foreign Application Priority Data
Feb. 28, 2022 (CN) 202210187766.X

(51) Int. Cl. C01D 15/08; C01D 3/06

(52) U.S. Cl. CPC C01D 15/08; C01D 3/06

(57) ABSTRACT

The invention discloses a mineralization method of a calcium chloride-type from lithium-containing salt lake brine by evaporation and brine mixing, comprising the following steps of: (1) naturally evaporating the calcium chloride-type from lithium-containing salt lake brine to precipitate sodium salt and potassium-containing mixed salt; and (2) when calcium in the brine is saturated, adding saturated solution of magnesium chloride in a certain proportion for brine mixing operation, and then naturally evaporating to precipitate carnallite, wherein a lithium-containing old brine with low potassium and sodium contents is obtained when magnesium in the brine is saturated. The method has the characteristics of simple process, simple and convenient operation, high potassium yield and easy extraction of lithium from lithium-containing brine, and has practical significance for the development and utilization of potassium and lithium resources in calcium chloride salt lakes.

### CROSS-REFERENCE TO RELATED APPLICATION

This present disclosure is a national stage filing under 35 U.S.C. § 371 of international application number PCT/CN2022/115292, filed Aug. 26, 2022, which claims priority to Chinese patent application No. 202210187766X, filed on Feb. 28, 2022. The contents of the international application are incorporated herein by reference in its entirety.

### TECHNICAL FIELD

The invention belongs to the technical field of extracting lithium from a salt lake, and more particularly, to a mineralization method of a calcium chloride-type from lithium-containing salt lake brine by evaporation and brine mixing.

### BACKGROUND

Generally, the processes of preparing potassium chloride by extracting potassium and preparing lithium carbonate by extracting lithium from lithium-containing salt lake brine mainly include the steps of sun-curing an original salt lake brine to obtain a potassium-containing mixed salt (including sodium chloride, potassium chloride and carnallite) firstly, then subjecting the potassium-containing mixed salt to pulp making, flotation or reverse flotation, decomposition and crystallization, screening and dehalogenation to obtain crude potassium, and then washing and dehalogenating the crude potassium again to obtain refined potassium which is potassium chloride with higher purity. After the carnallite is precipitated from the tedded brine, the remaining liquid phase contains a large amount of magnesium chloride, lithium chloride after enrichment and concentration, and a small amount of sodium chloride and potassium chloride, which is usually called lithium-containing old brine. Because the contents of K⁺ and Na⁺ ions in the lithium-containing old brine are low, electrodialysis membrane or nanofiltration membrane method may be used to separate positive monovalent lithium ions from positive divalent calcium and magnesium ions to obtain a lithium-rich solution. The lithium-rich solution is then subjected to evaporation and concentration, impurity removal and lithium precipitation to obtain a crude lithium carbonate, and then the crude lithium carbonate is washed, dried and demagnetized to obtain a battery-grade lithium carbonate. The preparation process of the potassium chloride is very mature, and has been widely used in the preparation process of potassium chloride by extracting potassium from various salt lakes at home and abroad. The extraction of lithium from the lithium-containing old brine by the electrodialysis membrane and nanofiltration membrane methods has also been industrialized. For example, the process of extracting lithium from the lithium-containing old brine by the electrodialysis membrane method to prepare a battery-grade lithium carbonate in East Tai Jinaier Salt Lake has achieved an industrial production of 20,000 tons/year, and the process of extracting lithium from the salt lake brine by the nanofiltration membrane method to prepare the lithium carbonate in Yiliping Salt Lake has also achieved an industrial production of 10,000 tons/year.

However, the above-mentioned lithium extraction processes cannot be used in the calcium chloride salt lake brine. If the above-mentioned processes are adopted, not only will the yield of the beneficial component potassium be low, but also the membrane method can only separate positive monovalent ion from positive divalent ions, and in the case of a large number of other positive monovalent impurity ions (such as K⁺), it will also affect the lithium extraction efficiency of the subsequent membrane method. Therefore, how to simply and efficiently recover the potassium and lithium resources from the calcium chloride salt lake brine is an urgent problem to be solved.

### SUMMARY

The invention aims at solving at least one of the technical problems in the prior art. Therefore, the invention provides a mineralization method of a calcium chloride-type from lithium-containing salt lake brine by evaporation and brine mixing which has the characteristics of simple process, simple and convenient operation, high potassium yield and easy extraction of lithium from lithium-containing brine, and has practical significance for the development and utilization of potassium and lithium resources in calcium chloride salt lakes.

The above-mentioned technical objects of the invention are achieved by the following technical solutions.

A mineralization method of a calcium chloride-type from lithium-containing salt lake brine by evaporation and brine mixing includes the following steps of: (1) naturally evaporating a calcium chloride-type from lithium-containing salt lake brine to precipitate sodium salt and potassium-containing mixed salt; and (2) when calcium in the brine is saturated, adding saturated solution of magnesium chloride in a certain proportion for brine mixing operation, and then naturally evaporating to precipitate carnallite, wherein a lithium-containing old brine with low potassium and sodium contents is obtained when magnesium in the brine is saturated.

Preferably, in step (1), after the calcium chloride-type from lithium-containing salt lake brine is naturally evaporated to precipitate sodium chloride, when the potassium in the brine in a sodium chloride pool is saturated, the brine is pumped into a potassium mixed salt pool for evaporating continuously to precipitate the potassium-containing mixed salt.

Preferably, in step (1), the calcium chloride-type from lithium-containing salt lake brine is located in a potassium chloride area in a phase diagram of a five-component water-salt system containing Na⁺, K⁺, Mg²⁺, Ca²⁺//Cl⁻—H₂O at 25° C. and a mass ratio of Ca/Mg is 2 to 50.

Preferably, in step (1), when potassium in the brine is saturated, K⁺ is between 23 g/L and 28 g/L, Ca²⁺ is between 120 g/L and 180 g/L, and Mg²⁺ is between 3 g/L and 8 g/L.

Preferably, in step (2), when calcium in the brine is saturated, K⁺ is between 22 g/L and 35 g/L, Ca²⁺ is between 140 g/L and 240 g/L, and Mg²⁺ is between 4 g/L and 9 g/L.

Preferably, in step (2), the ratio in the brine mixing operation is that the saturated solution of magnesium chloride is added according to a molar ratio of the calcium-saturated brine to total Mg/K in the saturated solution of magnesium chloride of 2 to 10 for brine mixing.

Preferably, in step (2), the brine mixing ratio in the brine mixing operation is that the saturated solution of magnesium chloride is added according to a molar ratio of the calcium-saturated brine to the total Mg/K in the saturated solution of magnesium chloride of 2.5 to 7.5 for brine mixing.

Preferably, in step (2), when the magnesium in the brine is saturated, the brine with K⁺ between 0.5 g/L and 5 g/L, Ca²⁺ between 140 g/L and 200 g/L and Mg²⁺ between 30 g/L and 80 g/L is the lithium-containing old brine with low potassium and sodium contents.

A lithium-containing old brine is prepared by the brine-mixing mineralization method above.

A battery-grade lithium carbonate is obtained by separating the lithium-containing old brine by an electrodialysis membrane method or a nanofiltration membrane, then subjecting the lithium-containing old brine to evaporation and concentration, impurity removal and lithium precipitation to obtain a crude lithium carbonate, and then washing, drying and demagnetizing the crude lithium carbonate.

The invention has the beneficial effects that: the mineralization method of a calcium chloride-type from lithium-containing salt lake brine by evaporation and brine mixing of the invention separates K⁺ in the calcium-saturated brine in the form of carnallite by using a salting-out effect in a water-salt system, adding the saturated solution of magnesium chloride and evaporating and concentrating in a salt field, thus achieving the object of high-efficiency extraction of potassium in a chloride-type salt lake brine with high calcium content, and obtaining high-lithium brine with low potassium and sodium contents. This method utilizes the unique climate environment of salt lake, which is simple, efficient, energy-saving, environment-friendly and low-cost, effectively solves the technical problem of incomplete potassium precipitation in the evaporation and concentration process of the calcium chloride salt lake brine, but also provides excellent raw materials for subsequent lithium extraction by the membrane method.

### BRIEF DESCRIPTION OF THE DRAWINGS

FIG. 1 is a process flowchart of the invention;

FIG. 2 is a phase diagram of a five-component water-salt system containing Na⁺, K⁺, Mg²⁺, Ca²⁺//Cl⁻—H₂O, wherein the points in Area A is the salting-out route before brine mixing, and the points in Area B is the salting-out route after brine mixing;

FIG. 3A is the enlarged drawing of area A in FIG. 2, and FIG. 3B is the enlarged drawing of area B in FIG. 2.

### DETAILED DESCRIPTION

The invention will be further explained in detail by taking the following 3Q Salt Lake brine in Argentina as an example to evaporate and mix brine to prepare a potassic salt ore and a lithium-containing old brine with low potassium and sodium contents with reference to the specific examples of the invention. In the examples, lithium, calcium, potassium, sodium, magnesium and boron in the brine are determined by inductively coupled plasma atomic emission spectrometry (ICP-OES), and chloride ions are determined by argentometry.

The invention will be further described in detail below with reference to the specific examples.

### Example 1

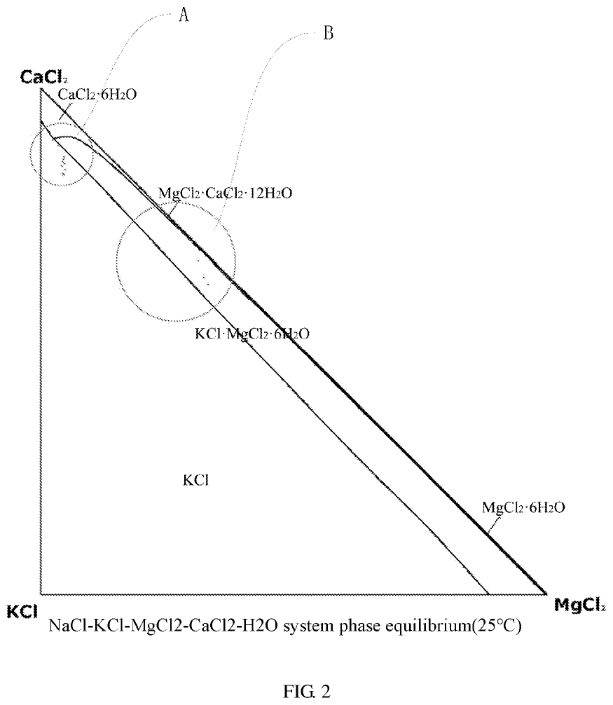

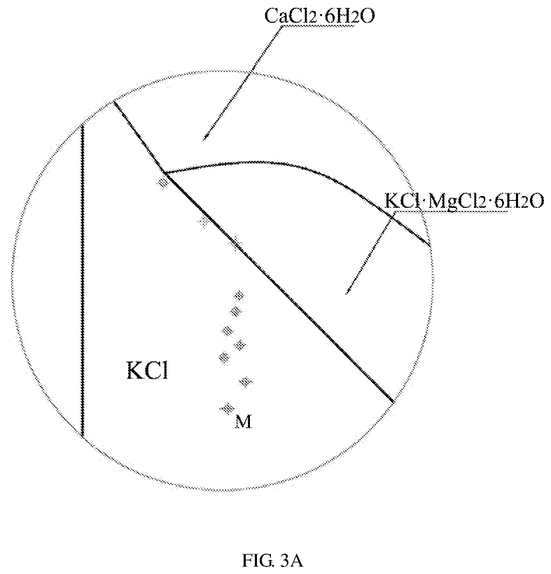

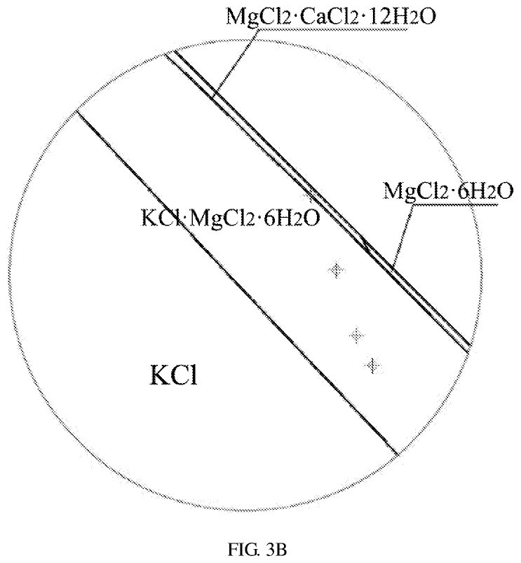

The raw material of Example 1 was brine taken from Well PB1 of 3Q Salt Lake in Argentina, which had the chemical compositions shown in Table 1-1, and belonged to a calcium chloride salt lake brine system. As shown in FIG. 2, FIG. 3A and FIG. 3B, a brine composition point of the brine was located in the potassium chloride area in a phase diagram of a five-component water-salt system containing Na⁺, K⁺, Mg²⁺, Ca²⁺//Cl⁻—H₂O at 25° C.

TABLE 1-1
Component content table of calcium-saturated brine

| | Ion content (g/L) | | | | | | Density | |
|---|---|---|---|---|---|---|---|---|
| Item | Li⁺ | Na⁺ | K⁺ | Mg²⁺ | Ca²⁺ | Cl⁻ | (g/ml) | Ca/Mg |
| Content | 1.220 | 60.610 | 13.48 | 2.235 | 61.27 | 219.39 | 1.2000 | 27.41 |

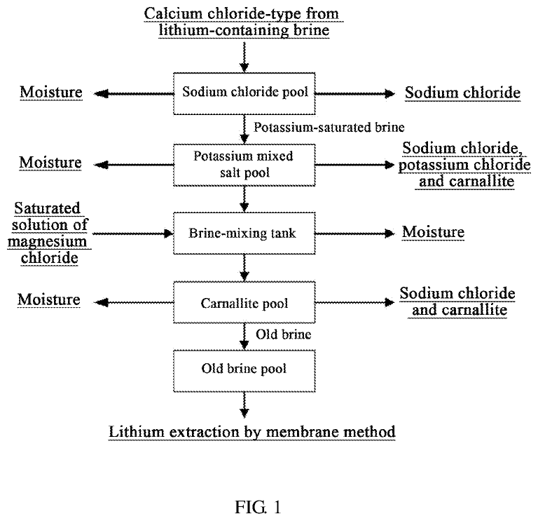

As shown in FIG. 1, a mineralization method of a calcium chloride-type from lithium-containing salt lake brine by evaporation and brine mixing, including the following steps of:
(1) taking 35 kg of raw material, and naturally evaporating the raw materials in a sodium chloride pool to precipitate sodium chloride, and when K⁺ was 27.06 g/L, Mg²⁺ was 5.607 g/L and Ca²⁺ was 138.70 g/L, carrying out solid-liquid separation to obtain 4.22 kg of sodium chloride solid;
(2) pumping the liquid separated in step (1) into a potassium mixed salt pool, naturally evaporating the liquid continuously to precipitate potassium-containing mixed salt minerals, and when K⁺ was 30.44 g/L, Mg²⁺ was 7.130 g/L and Ca²⁺ was 196.70 g/L, carrying out solid-liquid separation, wherein minerals obtained were mixed salts of sodium chloride, potassium chloride and carnallite, which were called potassium mixed salt minerals; 0.67 kg of potassium mixed salt mineral were precipitated, and meanwhile, 15.40 kg of calcium-saturated brine were obtained;
(3) pumping 15.40 kg of calcium-saturated brine into a brine-mixing tank, then adding saturated solution of magnesium chloride according to a molar ratio of total Mg/K of 4.27 for brine mixing, and then directly pumping the brine into a carnallite pool for natural evaporation to precipitate carnallite; and
(4) when K⁺ was 1.47 g/L, Mg²⁺ was 51.60 g/L and Ca²⁺ was 161.17 g/L, carrying out solid-liquid separation and pumping the separated liquid into an old brine pool, wherein minerals obtained were mixed salts composed of sodium chloride, epsomite and carnallite, which were called carnallite; 1.91 kg of carnallite were precipitated, and meanwhile, 14.51 kg of lithium-containing old brine with low potassium and sodium contents were obtained.

The components of the potassium mixed salt, carnallite and lithium-containing old brine with low potassium and sodium contents obtained were shown in Table 1-2.

TABLE 1-2
Component contents of old brine and potassium
salt after evaporation and brine mixing

| | Ion content (s: % or l: g/L) | | | | | | Density |
|---|---|---|---|---|---|---|---|
| Item | Li⁺ | Na⁺ | K⁺ | Mg²⁺ | Ca²⁺ | Cl⁻ | (g/ml) |
| Potassium-mixed salt | 0.02 | 22.41 | 11.27 | 1.36 | 0.82 | 50.25 | |
| Carnallite | 0.02 | 0.17 | 12.74 | 8.25 | 1.03 | 37.82 | |
| Lithium-containing old | 3.42 | 1.95 | 1.47 | 51.60 | 161.17 | 457.43 | 1.4169 |
| brine | | | | | | | |

### Example 2

The raw material of Example 2 was brine taken from Well PB3 of 3Q Salt Lake in Argentina, which had the chemical compositions shown in Table 2-1, and belonged to a calcium chloride salt lake brine system. As shown in FIG. 2, FIG. 3A and FIG. 3B, a brine composition point of the brine was located in the potassium chloride area in a phase diagram of a five-component water-salt system containing Na⁺, K⁺, Mg²⁺, Ca²⁺//Cl⁻—H₂O at 25° C.

TABLE 2-1
Component content table of calcium-saturated brine

| | Ion content (g/L) | | | | | | Density | |
|---|---|---|---|---|---|---|---|---|
| Item | Li⁺ | Na⁺ | K⁺ | Mg²⁺ | Ca²⁺ | Cl⁻ | (g/ml) | Ca/Mg |
| Content | 1.158 | 66.900 | 11.940 | 2.121 | 62.970 | 218.255 | 1.2372 | 29.69 |

As shown in FIG. 1, a mineralization method of a calcium chloride-type from lithium-containing salt lake brine by evaporation and brine mixing, including the following steps of:
(1) taking 245 kg of raw material, and naturally evaporating the raw materials in a sodium chloride pool to precipitate sodium chloride, and when K⁺ was 26.71 g/L, Mg²⁺ was 4.97 g/L and Ca²⁺ was 141.70 g/L, carrying out solid-liquid separation to obtain 29.73 kg of sodium chloride solid;
(2) pumping the liquid separated in step (1) into a potassium mixed salt pool, naturally evaporating the liquid continuously to precipitate potassium-containing mixed salt minerals, and when K⁺ was 26.69 g/L, Mg²⁺ was 5.89 g/L and Ca²⁺ was 214.90 g/L, carrying out solid-liquid separation, wherein minerals obtained were mixed salts of sodium chloride, potassium chloride and carnallite, which were called potassium mixed salt minerals, 4.45 kg of potassium mixed salt mineral were precipitated, and meanwhile, 79.52 kg of calcium-saturated brine were obtained;
(3) pumping 79.52 kg of calcium-saturated brine into a brine-mixing tank, then adding saturated solution of magnesium chloride according to a molar ratio of total Mg/K of 3.50 for brine mixing, and then directly pumping the brine into a carnallite pool for natural evaporation to precipitate carnallite; and
(4) when K⁺ was 2.53 g/L, Mg²⁺ was 37.97 g/L and Ca²⁺ was 190.05 g/L, carrying out solid-liquid separation and pumping the separated liquid into an old brine pool, wherein minerals obtained were mixed salts composed of sodium chloride, epsomite and carnallite, which were called carnallite; 10.48 kg of carnallite were precipitated, and meanwhile, 86.79 kg of lithium-containing old brine with low potassium and sodium contents were obtained.

The components of the potassium mixed salt, carnallite and lithium-containing old brine with low potassium and sodium contents obtained were shown in Table 2-2.

TABLE 2-2
Component contents of old brine and potassium
salt after evaporation and brine mixing

| | Ion content (s: % or l: g/L) | | | | | | Density |
|---|---|---|---|---|---|---|---|
| Item | Li⁺ | Na⁺ | K⁺ | Mg²⁺ | Ca²⁺ | Cl⁻ | (g/ml) |
| Potassium-mixed salt | 0.07 | 16.97 | 17.60 | 2.68 | 3.50 | 56.49 | |
| Carnallite | 0.02 | 1.64 | 12.28 | 7.86 | 1.16 | 38.76 | |
| Lithium-containing old | 3.91 | 2.70 | 2.53 | 37.97 | 190.05 | 473.40 | 1.4262 |
| brine | | | | | | | |

### Example 3

The raw material of Example 3 was brine taken from Well PB7 of 3Q Salt Lake in Argentina, which had the chemical compositions shown in Table 3-1, and belonged to a calcium chloride salt lake brine system. As shown in FIG. 2, FIG. 3A and FIG. 3B, a brine composition point of the brine was located in the potassium chloride area in a phase diagram of a five-component water-salt system containing Na⁺, K⁺, Mg²⁺, Ca²⁺//Cl⁻—H₂O at 25° C.

TABLE 3-1
Component content table of calcium-saturated brine

| | Ion content (g/L) | | | | | | Density | |
|---|---|---|---|---|---|---|---|---|
| Item | Li⁺ | Na⁺ | K⁺ | Mg²⁺ | Ca²⁺ | Cl⁻ | (g/ml) | Ca/Mg |
| Content | 1.346 | 56.150 | 12.450 | 2.333 | 59.570 | 213.590 | 1.2567 | 25.53 |

As shown in FIG. 1, a mineralization method of a calcium chloride-type from lithium-containing salt lake brine by evaporation and brine mixing, including the following steps of:
(1) taking 210 kg of raw material, and naturally evaporating the raw materials in a sodium chloride pool to precipitate sodium chloride, and when K⁺ was 24.32 g/L, Mg²⁺ was 5.05 g/L and Ca²⁺ was 137.40 g/L, carrying out solid-liquid separation to obtain 25.02 kg of sodium chloride solid;
(2) pumping the liquid separated in step (1) into a potassium mixed salt pool, naturally evaporating the liquid continuously to precipitate potassium-containing mixed salt minerals, and when K⁺ was 22.32 g/L, Mg²⁺ was 6.71 g/L and Ca²⁺ was 178.20 g/L, carrying out solid-liquid separation, wherein minerals obtained were mixed salts of sodium chloride, potassium chloride and carnallite, which were called potassium mixed salt minerals, 3.16 kg of potassium mixed salt mineral were precipitated, and meanwhile, 75.18 kg of calcium-saturated brine were obtained;
(3) pumping 75.18 kg of calcium-saturated brine into a brine-mixing tank, then adding saturated solution of magnesium chloride according to a molar ratio of total Mg/K of 5.0 for brine mixing, and then directly pumping the brine into a carnallite pool for natural evaporation to precipitate carnallite; and
(4) when K⁺ was 1.40 g/L, Mg²⁺ was 51.38 g/L and Ca²⁺ was 162.03 g/L, carrying out solid-liquid separation and pumping the separated liquid into an old brine pool, wherein minerals obtained were mixed salts composed of sodium chloride, epsomite and carnallite, which were called carnallite; 8.36 kg of carnallite were precipitated, and meanwhile, 79.53 kg of lithium-containing old brine with low potassium and sodium contents were obtained.

The components of the potassium mixed salt, carnallite and lithium-containing old brine with low potassium and sodium contents obtained were shown in Table 3-2.

TABLE 3-2
Component contents of old brine and potassium
salt after evaporation and brine mixing

| | Ion content (s: % or l: g/L) | | | | | | Density |
|---|---|---|---|---|---|---|---|
| Item | Li⁺ | Na⁺ | K⁺ | Mg²⁺ | Ca²⁺ | Cl⁻ | (g/ml) |
| Potassium-mixed salt | 0.04 | 21.00 | 19.01 | 0.55 | 2.14 | 58.66 | |
| Carnallite | 0.02 | 0.02 | 12.80 | 8.28 | 1.04 | 37.73 | |
| Lithium-containing old | 3.44 | 1.92 | 1.40 | 51.38 | 162.03 | 458.30 | 1.4191 |
| brine | | | | | | | |

### Example 4

The battery-grade lithium carbonate was obtained by following process: treating the lithium-containing old brine from any one of Examples 1 to 3 by electrodialysis membrane method or nanofiltration membrane, then obtaining crude lithium carbonate after evaporation and concentration, impurity removal and lithium precipitation, and then washing, drying and demagnetizing the crude lithium carbonate to gain the final product.

The above examples are preferred examples of the invention, but the examples of the invention are not limited to the above examples, and any other changes, modifications, substitutions, combinations, and simplifications made without departing from the spirit and scope of the invention should be equivalent replacement means, and are included in the protection scope of the invention.

1. A mineralization method of a calcium chloride-type lithium-containing salt lake brine by evaporation and brine mixing, comprising the following steps of:
(1) naturally evaporating a calcium chloride-type lithium-containing salt lake brine to precipitate a sodium salt and a potassium-containing mixed salt; and
(2) adding a saturated solution of magnesium chloride in a proportion into the brine when calcium is saturated for brine mixing, and then performing naturally evaporation to precipitate carnallite, wherein a lithium-containing old brine with low potassium and sodium contents is obtained when magnesium in the brine is saturated;
wherein in step (1), the calcium chloride-type lithium-containing salt lake brine is located in a potassium chloride area in a phase diagram of a quinary salt-water system Na⁺, K⁺, Mg²⁺, Ca²⁺//Cl⁻—H₂O, at 25° C., and a mass ratio of Ca/Mg is 2 to 50;
wherein in step (2), a proportion for brine mixing is such that the saturated solution of magnesium chloride is added according to a total Mg/K molar ratio of a calcium-saturated brine and the saturated solution of magnesium chloride of 2 to 10; and when magnesium in the brine is saturated, the brine with K⁺ between 0.5 g/L and 5 g/L, Ca²⁺ between 140 g/L and 200 g/L and Mg²⁺ between 30 g/L and 80 g/L is the lithium-containing old brine with low potassium and sodium contents.

2. The mineralization method of the calcium chloride-type lithium-containing salt lake brine by evaporation and brine mixing according to claim 1, wherein in step (1), after the calcium chloride-type lithium-containing salt lake brine is naturally evaporated to precipitate sodium chloride, when potassium in the brine in a sodium chloride pool is saturated, the brine is pumped into a potassium mixed salt pool for evaporating continuously to precipitate the potassium-containing mixed salt.

3. (canceled)

4. The mineralization method of the calcium chloride-type lithium-containing salt lake brine by evaporation and brine mixing according to claim 2, wherein in step (1), when the potassium in the brine is saturated, K⁺ is between 23 g/L and 28 g/L, Ca²⁺ is between 120 g/L and 180 g/L, and Mg²⁺ is between 3 g/L and 8 g/L.

5. The mineralization method of the calcium chloride-type lithium-containing salt lake brine by evaporation and brine mixing according to claim 1, wherein in step (2), when the calcium in the brine is saturated, K⁺ is between 22 g/L and 35 g/L, Ca²⁺ is between 140 g/L and 240 g/L, and Mg²⁺ is between 4 g/L and 9 g/L.

6. (canceled)

7. The mineralization method of the calcium chloride-type lithium-containing salt lake brine by evaporation and brine mixing according to claim 1, wherein in step (2), the proportion for brine mixing is such that the saturated solution of magnesium chloride is added according to a total Mg/K molar ratio of the calcium-saturated brine and the saturated magnesium chloride solution of 2.5 to 7.5.

8. (canceled)

9. A lithium-containing old brine prepared by the mineralization method according to claim 1.

10. A battery-grade lithium carbonate, wherein the battery-grade lithium carbonate is obtained by a method comprising: separating the lithium-containing old brine of claim 9 by an electrodialysis membrane method or a nanofiltration membrane, then subjecting to evaporation and concentration, impurity removal and lithium precipitation to obtain a crude lithium carbonate, and then washing, drying and demagnetizing the crude lithium carbonate.

11. A lithium-containing old brine prepared by the mineralization method according to claim 2.

12. (canceled)

13. A lithium-containing old brine prepared by the mineralization method according to claim 4.

14. A lithium-containing old brine prepared by the mineralization method according to claim 5.

15. (canceled)

16. A lithium-containing old brine prepared by the mineralization method according to claim 7.

17. (canceled)

18. A battery-grade lithium carbonate, wherein the battery-grade lithium carbonate is obtained by a method comprising: separating the lithium-containing old brine of claim 11 by an electrodialysis membrane method or a nanofiltration membrane, then subjecting to evaporation and concentration, impurity removal and lithium precipitation to obtain a crude lithium carbonate, and then washing, drying and demagnetizing the crude lithium carbonate.

19. A battery-grade lithium carbonate, wherein the battery-grade lithium carbonate is obtained by a method comprising: separating the lithium-containing old brine of claim 13 by an electrodialysis membrane method or a nanofiltration membrane, then subjecting to evaporation and concentration, impurity removal and lithium precipitation to obtain a crude lithium carbonate, and then washing, drying and demagnetizing the crude lithium carbonate.

20. A battery-grade lithium carbonate, wherein the battery-grade lithium carbonate is obtained by a method comprising: separating the lithium-containing old brine of claim 14 by an electrodialysis membrane method or a nanofiltration membrane, then subjecting to evaporation and concentration, impurity removal and lithium precipitation to obtain a crude lithium carbonate, and then washing, drying and demagnetizing the crude lithium carbonate.

21. A battery-grade lithium carbonate, wherein the battery-grade lithium carbonate is obtained by a method comprising: separating the lithium-containing old brine of claim 16 by an electrodialysis membrane method or a nanofiltration membrane, then subjecting to evaporation and concentration, impurity removal and lithium precipitation to obtain a crude lithium carbonate, and then washing, drying and demagnetizing the crude lithium carbonate.
